(19) United States
(12) Patent Application Publication
(10) Pub. No.: US 2003/0084158 A1
(43) Pub. Date: May 1, 2003

(54) Communication band control system

(76) Inventors: Hiroyuki Saito, Kawasaki (JP); Hideki Hagiwara, Kawasaki (JP); Yoshimitsu Hamasaki, Kawasaki (JP); Junko Shiraishi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/075,644

(22) Filed: Feb. 13, 2002

(30) Foreign Application Priority Data
Oct. 31, 2001 (JP) 2001-334584

(51) Int. Cl. G06F 15/16

(52) U.S. Cl. 709/226; 709/229

(57) ABSTRACT

A communication band control system opens an unused portion of a communication band previously allocated to a certain user, to other users, and accepts use requests of all or a part of the unused portion, from other users. And the communication band control system allocates all or a part of the unused portion which corresponds to use requests, to a different user. In this way, the unused portion of the communication band of a certain user is resold to a different user. As a result, communication band use requests from users can be coped with flexibly. The utilization factor of the communication bands is increased.

### BACKGROUND OF THE INVENTION

1. Field of the Invention

The present invention relates to a communication band control system that controls allocation of communication bands in a network in which communication bands have been allocated to one or more users previously.

2. Description of the Related Art

In the field of the communication technique, a communication facility provider (carrier) allocates a bandwidth and a use time zone that a user desires to utilize (hereafter simply referred to also as “band”) among communication bands (there is a limit) that can be provided by communication facilities, to the user, according to a contract with the user. The user (a subscriber to communication service, also referred to as “contractor”) who has made a contract with the carrier pays a charge for using according to the magnitude of the band. The charge for using becomes higher as the band becomes great.

The band (contract band) reserved by the subscriber is used according to the situation, and may have a portion that is not usually used (unused portion). Since this unused portion is always allocated to the subscriber on the basis of the contract, however, the subscribed must pay the charge for using of the unused portion. Many of such situations occur in subscribers (called big users) who reserve a wideband in order to always ensure such a state that a large amount of data can be communicated. Sometimes, therefore, big users must pay high charges for using including charges for using of unused portions.

On the other hand, there is such a method that the user makes a contract about a band the user usually uses, and in the case where a need to use a further band occurs, the user makes the carrier allocate a necessary band according to a separate contract. In this method, however, whether the user can utilize a desired band depends on the situation of allocation of bands to other users (contract situation), and consequently required bands are not reserved sometimes.

In this way, the utilization band of the user is allocated by conclusion of a contract with the carrier, and the allocation situation changes only by content alteration and cancellation of the contract, and conclusion of a new contract.

Even in the case where a subscriber wants to provide another user with a vacant band included in a contract band, therefore, it cannot be implemented easily because a contract alteration is needed. Effective utilization of vacant bands is thus impossible.

On the other hand, even if a user who desires use of a certain band wants to take over the use of the band from another user who reserves the band, implementation thereof needs a contract alteration of the other user, and consequently it cannot be implemented easily.

If communication bands are occupied to some users and unused portions of these users are large, therefore, communication bands allocated to these users cannot be allocated to other users easily. This is a cause of the utilization factor of communication bands being prevented from being improved. On the other hand, for fully satisfying traffic demands of users, the carrier must execute plant investment.

### SUMMARY OF THE INVENTION

An object of the present invention is to provide a communication band control system capable of flexibly coping with use requests of communication bands from users.

In order to solve the above-described problems, the present invention adopts a configuration heretofore described. In accordance with the present invention, a communication band control system for executing communication band allocation control in a network in which communication bands are previously allocated to one or more users, the communication band control system includes: opening means for opening an unused portion of a communication band previously allocated to a certain user, to other users; acceptance means for accepting use requests of all or a part of the unused portion, from other users; and allocation alteration means for allocating all or a part of the unused portion which corresponds to use requests, to a different user. According to the present invention, all or a part of an unused portion of a communication band previously allocated to a certain user can be allocated to other users. Therefore, it becomes possible to flexibly cope with communication band use requests from users. Further, since all or a part of an unused portion is altered to be allocated to other users and other users use it, the utilization factor of the communication bands is increased.

Preferably, the communication band control system according to the present invention further includes rent billing means for billing rents to be paid to the certain user, for all or a part of the unused portion allocated temporarily to a different user, by the different user. Thus, the user who provides all or a part of the unused portion to utilization of other users receives a rent from the different user as a reward. The user can appropriate the rent for a rent of the communication band previously allocated to the user. As a result, the use cost of the communication band can be reduced.

Preferably, the communication band control system according to the present invention further includes contention processing means, responsive to a contention of use requests from a plurality of other users for the unused portion, for selecting a user having a highest use factor of the unused portion, as the different user to be allocated all or a part of the unused portion. By doing so, the utilization factor of communication bands can be increased.

Preferably, in the communication band control system according to the present invention, the allocation alteration means contains a time limit for insurance of a communication band desired in a use request by an unselected user included in other users who are not selected by the contention processing means; when allocating a part of the unused portion to the different user selected by the contention processing means, the allocation alteration means allocates a remaining part of the unused portion to the unselected user; and the allocation alteration means allocates unused portions of communication bands opened to public thereafter and previously allocated to users except the nonpreferential user, to the nonpreferential user until a total value of the communication band allocated to the nonpreferential user within the time limit reaches a communication band desired in the use request. By doing so, the utilization factor of communication bands can be increased.

Preferably, the communication band control system according to the present invention further includes fee billing means, responsive to a communication band allocation alteration conducted by the allocation alteration means, for billing at least a user of the alteration destination for a fee. By doing so, the income of the carrier can be increased.

Preferably, in the communication band control system according to the present invention, the opening means opens a situation of a communication band previously allocated to a certain user to users via Internet in such a state as to reflect the unused portion and a portion for which the use request has been made. By doing so, the user can refer to the situation of the communication band in real time, and selling and buying (resale) of the communication bands in an on-demand form become possible.

### BRIEF DESCRIPTION OF THE DRAWINGS

FIG. 1 is a conceptual diagram of band resale;

FIG. 2 is a diagram showing a general configuration of a band management control system and an example of a management table of bands (band management table) managed by this system;

FIG. 3 is a diagram showing a function of OPS serving as a band management control system shown in FIG. 2;

FIG. 4 is a diagram showing a processing phase in resale processing;

FIG. 5 is a flow chart showing resale processing that implements first means;

FIG. 6 is a flow chart showing resale processing that implements first means;

FIG. 7 is a flow chart showing resale processing that implements first means;

FIG. 8 is a flow chart showing resale processing that implements first means;

FIG. 9 is a diagram showing a virtual matrix;

FIG. 10 is a diagram showing an example of a band information table;

FIG. 11 is a diagram showing an example of a virtual matrix;

FIG. 12 is a diagram showing a display example of communication route information;

FIG. 13 is a diagram showing a display example of a band buying and selling agreement/ordering situation (simple);

FIG. 14 is a diagram showing a display example of a band buying and selling agreement/ordering situation (detailed);

FIG. 15 is a diagram showing a display example of an individual user band buying and selling agreement/ordering situation;

FIG. 16 is a diagram showing an example of a band buying and selling ordering format;

FIG. 17 is a diagram showing an example of a band buying and selling agreement information management table;

FIG. 18 is a flowchart showing resale processing which implements second means;

FIG. 19 is a flow chart showing resale processing which implements second means; and

FIG. 20 is a flow chart showing resale processing which implements second means.

### DESCRIPTION OF THE PREFERRED EMBODIMENTS

Hereafter, embodiments of the present invention will be described by referring to the drawing. Configurations of the embodiments are nothing but examples. The present invention is not restricted to the configurations of the embodiments.

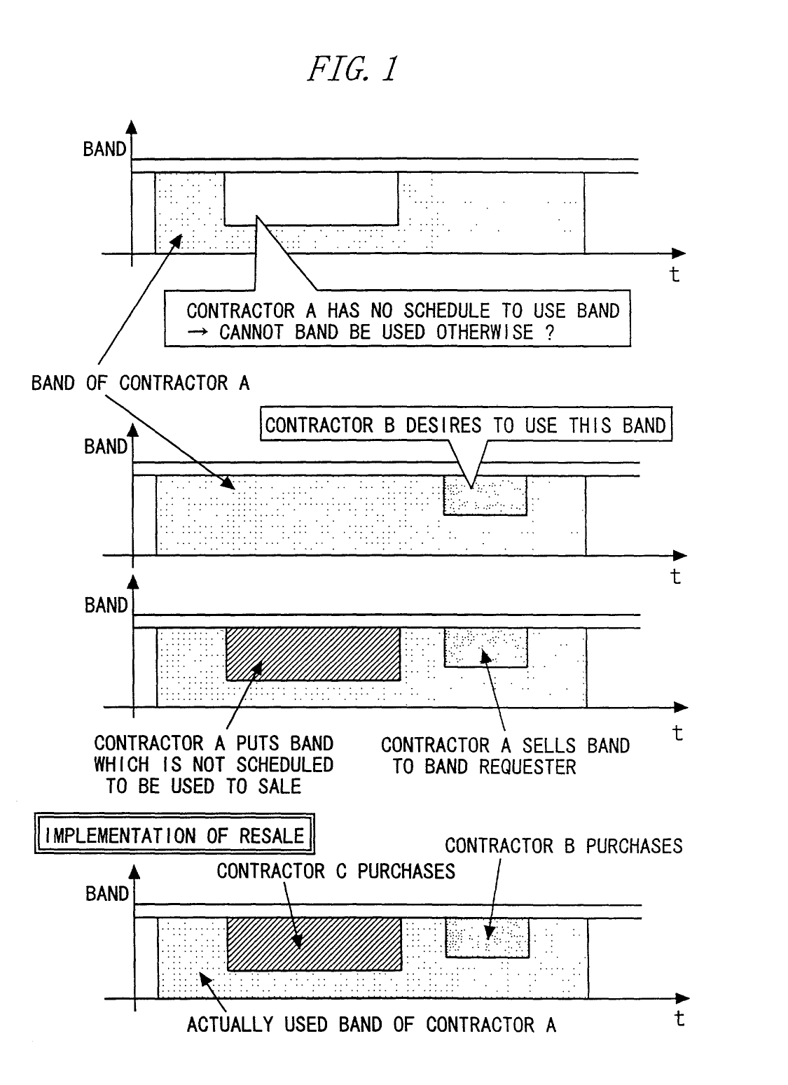

FIG. 1 is a conceptual diagram of band resale. Even in the case where a band and a time zone (hereafter simply referred to as “band” sometimes) which are not used temporarily occur in a band reserved by a certain user (contractor (subscriber) A in FIG. 1), the subscriber A must reserve the band and the time zone although they are left unused, in the conventional art. There is no means that utilizes this band.

Further, even if another user (a subscriber B in FIG. 1) desires to use a certain band (a band use request has occurred), communication cannot be conducted in the case where the band is not vacant (in the case where the band is reserved by the subscriber A in FIG. 1).

Against this, the present invention provides a communication band control system (band management control system), which implements the following means.

[First means] A certain user executes resale of vacant bands included in a communication band (contracted bands) already reserved by a contract, to other users. Thereby, vacant bands are used effectively.

[Second means] As for a band scheduled to be utilized in contracted bands of a certain user, the band is re-sold considering a band request condition (such as the charge).

It is defined as band resale for a user (subscriber) to provide all or a part of a contracted band to other users. Resale includes a subscriber's releasing a vacant band (unused portion) to another user who wants to use it in the case where a subscriber does not use the band included in a contracted band in a certain time zone, or a subscriber's releasing bands scheduled to be used and included in a contracted band to other users.

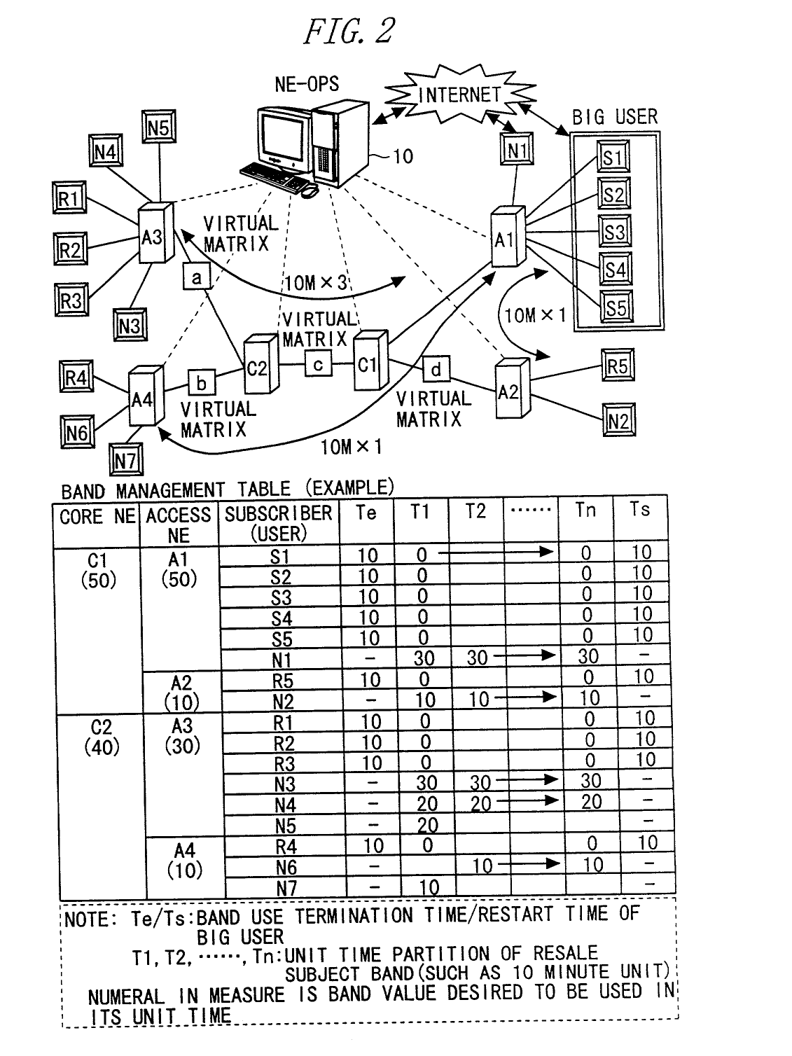

First, the first means implemented by a band management control system according to the present invention will be described. FIG. 2 is a diagram showing a general configuration of the band management control system, and an example of a management table of bands (band management table) managed by the system.

In FIG. 2, there is shown a communication facility (network) including a plurality of communication devices (NEs: Network Elements) A1, A2, A3, A4, C1 and C2 connected via communication lines, and an NE-OPS (Network Element-Operation System, hereafter referred to simply as “OPS”) 10 serving as a band management control system, which manages and controls the communication bands of the communication facility by managing and controlling the NEs.

The NEs A1 to A4 are access NEs, each of which accommodates terminal devices of users (subscribers) and transmits/receive data to/from the terminal devices. The NEs C1 and C2 are core NEs, each of which relays data supplied from the NEs A1 to A4. Communication between the terminal devices and the OPS 10 is made possible via the Internet.

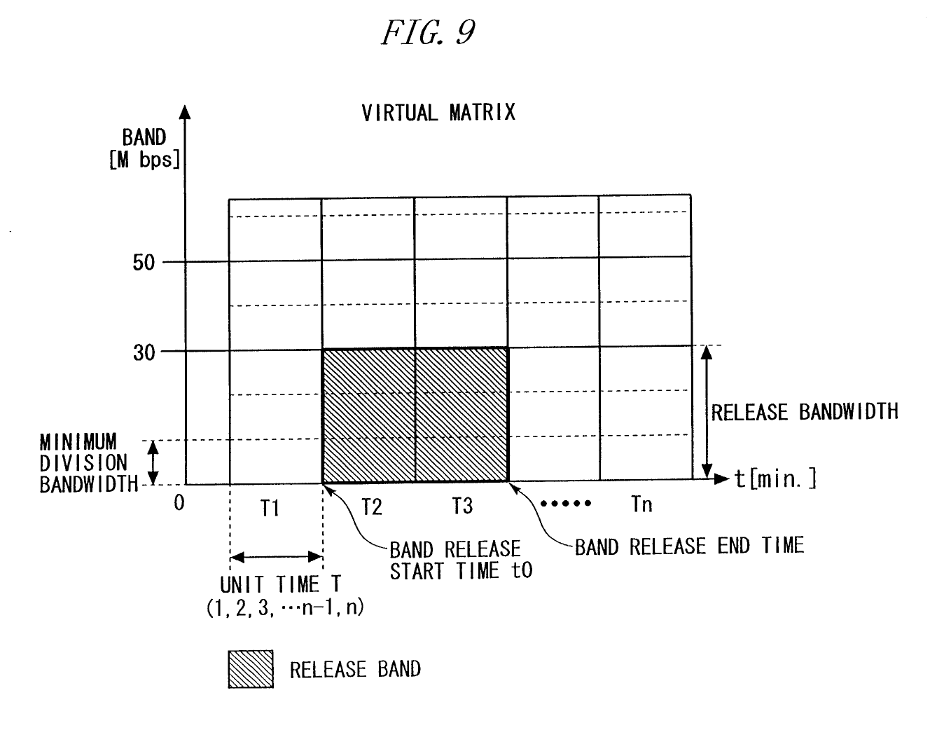

In the case where a big user who has reserved bands of terminal devices S1 to S5 shown in FIG. 2 releases the bands of terminal devices S1 to S5 (as for the incoming side, bands of the terminal devices R1 to R5), the OPS 10 conducts virtual matrix division on vacant bands by using virtual bands and unit times (see FIG. 9, which will be described later).

A user (subscriber) of each terminal device can always refer to virtual matrix information by provision from the OPS 10 via the Internet. Other subscribers (in the example of FIG. 2, users of terminal devices N1 to N7) refer to virtual matrix information, and reserve required bands and time zones at the OPS 10 (band use reservation). By a combination of a virtual band and a unit time, variable band and time use reservation can be conducted.

Thereafter, the OPS 10 side reads virtual matrix information, and sends a path information setting command to an NE, which should be altered, in band allocation state. As a result, band management control according to a user's request is executed without intervention of an operator, and a band and a time zone, which have been reserved, are allocated to a user who has made the reservation.

On the other hand, if reservations (user requests) from a plurality of subscribers overlap, then band allocation is conducted according to contention processing described later. Further, as efficient band use in the case where a vacant band has occurred as a result of the contention processing, nonpreferential band resale service (described later) is newly set. Band resale to users meeting the object thereof is thus accomplished. By executing the above-described processing, a high on-demand utilization factor of bands can be achieved.

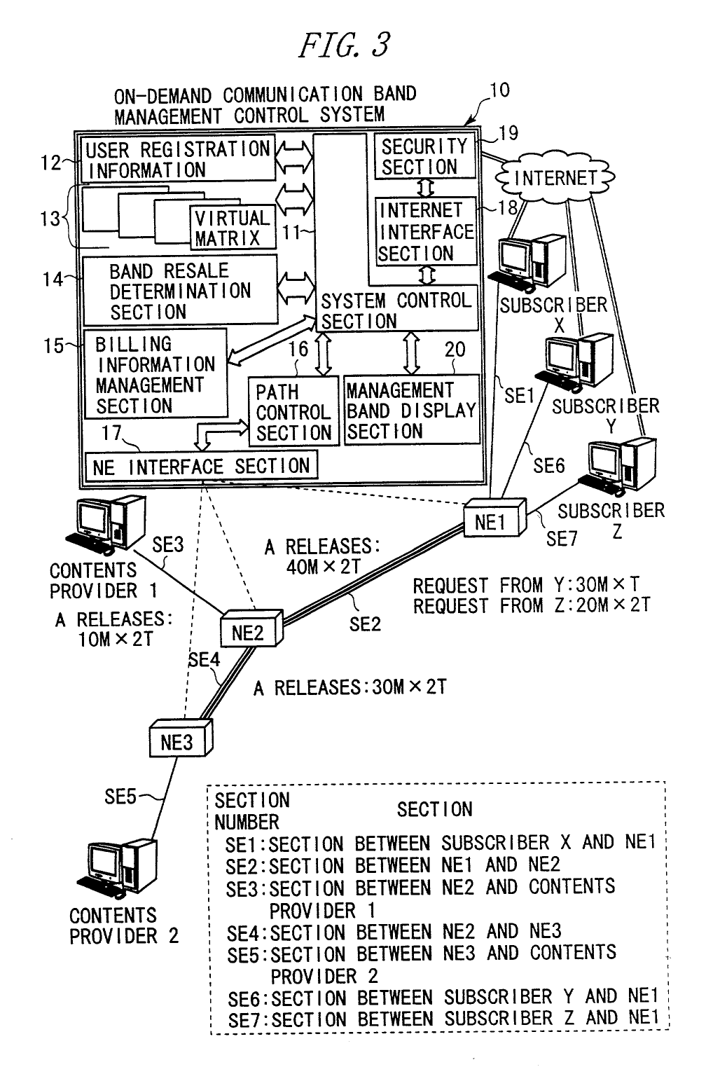

FIG. 3 is a diagram showing function blocks of the OPS 10 serving as the band management and control system shown in FIG. 2. However, a network and a user configuration shown in FIG. 3 are different from those shown in FIG. 2.

In FIG. 3, the OPS 10 is a computer including a processor (such as a CPU), a main memory, an auxiliary memory, a communication control device, input devices (such as a keyboard and a mouse), an output device (such as a display), and other peripheral devices (such as interface circuits). The CPU loads various programs stored in the auxiliary memory into the main memory, and executes the programs.

As a result, the OPS 10 functions as a communication band management and control system including a system control section 11, a user registration information management section 12, a virtual matrix management section 13, a band resale determination section 14, a billing information management section 15, a path control section 16, an NE interface section 17, an Internet interface section 18, a security section 19, and a management band display section 20.

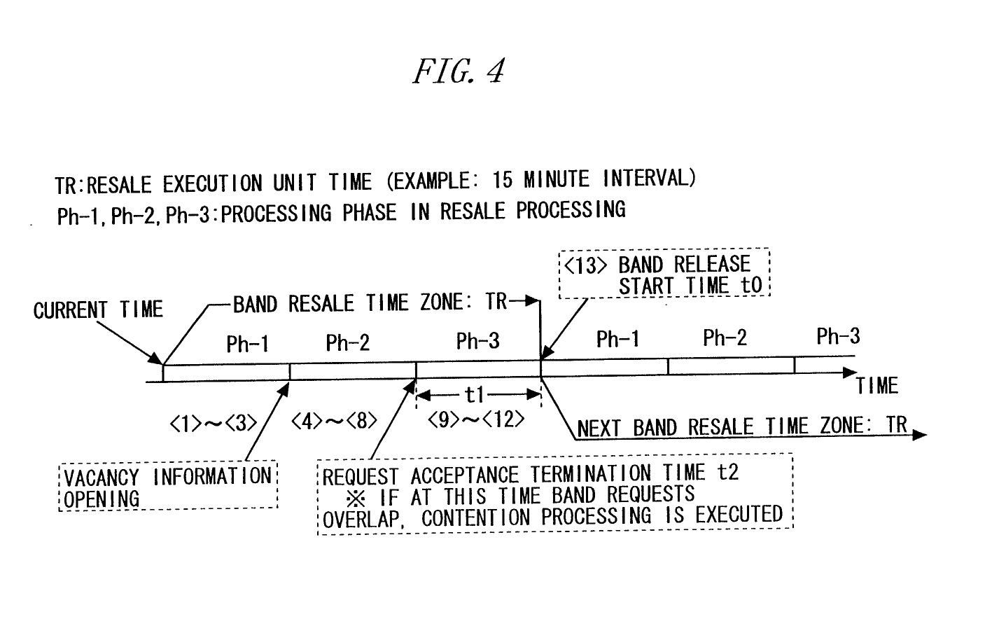

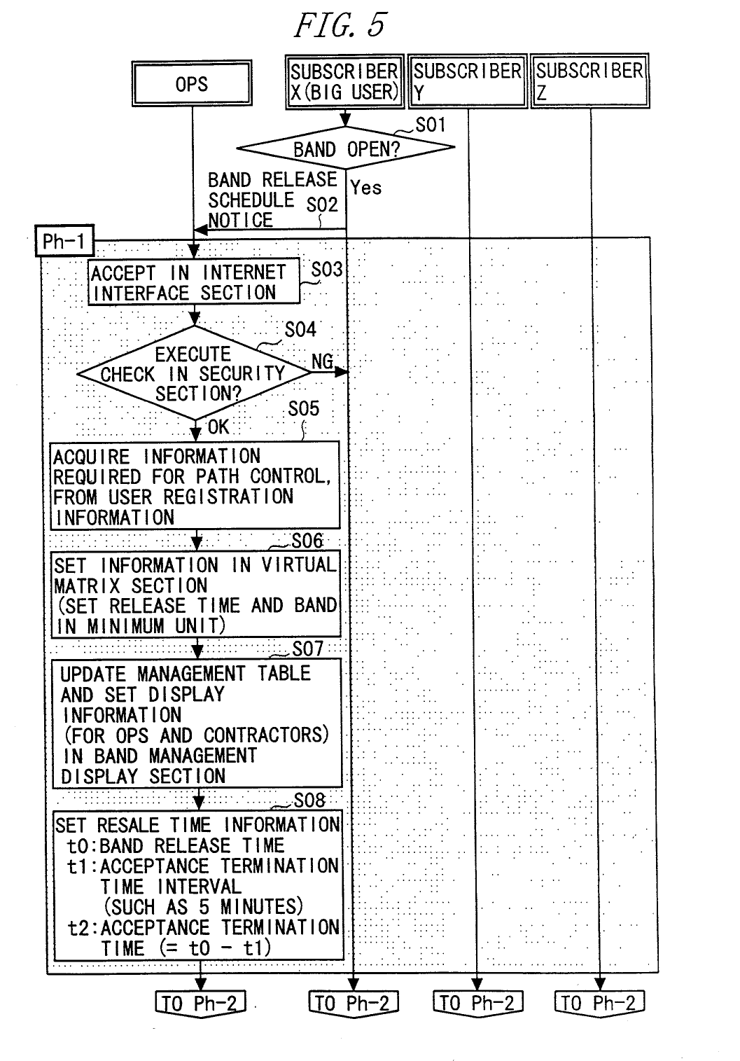

The OPS 10 executes resale processing by using the components shown in FIG. 3. FIG. 4 is a diagram showing processing phases in the resale processing. FIGS. 5 to 8 are flowcharts showing resale processing.

In FIG. 4, resale processing is processing conducted since release of unused bands in a contract band until the unused bands are allocated to other users and band control based thereon is executed. The resale processing includes three phases Ph-1, Ph-2 and Ph-3.

In the phase Ph-1, band release and vacant band setting are executed. In the phase Ph-2, resale acceptance is executed. In the phase Ph-3, band allocation determination and band control are executed. The resale processing is executed whenever a unit time (band resale time zone) TR of resale execution elapses (i.e., with a repetition period of TR). The unit time TR is set equal to, for example, approximately 15 minutes.

The phases Ph-1, Ph-2 and Ph-3 have the following contents.

Ph-1: Band Release and Vacant Band Setting

(1) Notice of a contract band release schedule of a subscriber

(2) Division of bandwidth and time (time zone) of a released band (unused portion) on a virtual matrix

(3) Update of a management table (vacant information setting)

Ph-2: Resale Acceptance

(4) Notice of vacancy information to user (subscriber) subordinate to a pertinent NE

(5) Presentation of information of bands, which can be connected (allocated) from the pertinent NE

(6) Presentation of a band use request

(7) Setting of the use band, occupation time, communication opposite party information, etc.

(8) Update of a management table

Ph-3: Band Allocation Determination and Band Control

(9) Management table search execution

(10) Contention processing execution

(11) Band user determination

(12) Management table update

(13) Band alteration and new path setting

Flow charts (resale processing) shown in FIGS. 5 to 8 will now be described by referring to FIG. 3. It is assumed that via the Internet the OPS 10 supplies subscribers with a web site whereby the subscriber can release unused portions in the contract band, present bands to be resold to other subscribers, and accept reservations (orders) therefor.

In the case where a subscriber A included in subscribers shown in FIG. 3 releases (resales) unused portions in the contract band to other subscribers, the subscriber A accesses the web site via the Internet, and transmits a band release schedule notice (resale request) to the OPS 10 (steps (hereafter referred to as S) 01 and 02).

The band release schedule notice contains user authentication information including subscriber identification information (subscriber ID), and information (release band information) indicating a scheduled release time zone of a band to be released (referred to as release band) of each section and its bandwidth. The term “section” refers to a communication path connecting NEs to each other or connecting an NE to the user's terminal device. A contraction band is allocated for each section

In the OPS 10, therefore, the band release schedule notice is accepted by the Internet interface section 18 (S03), and the security section 19 conducts a check by using the authentication information contained in the notice. If at this time the check results in NG (no good) (NG of S04), then the band release schedule notice is disregarded.

If the security section 19 has judged the band release schedule notice to be normal (OK of S04), then the band release schedule notice is supplied to the system control section 11, and the system control section 11 acquires information required for path control of a section corresponding to the band release schedule notice from the user registration information management section 12 (S05). The information required for the path control contains the subscriber ID (such as IP address) VPi, VCi, and contract band information.

The system control section 11 controls the virtual matrix management section (virtual matrix section) 13, and sets information. In other words, the system control section 11 creates a virtual matrix indicating the release band information of the subscriber A every section including a release band on the basis of release band information and contract band information of each section (S06).

FIG. 9 is a diagram showing a virtual matrix. As shown in FIG. 9, the virtual matrix is a matrix obtained by dividing a rectangle which indicates a contract band in a certain section of the subscriber into rectangular regions (minimum regions: partitions which correspond to unit rectangles) having a unit time Ti (i=1, 2, 3, . . . n−1, n) and a minimum division bandwidth (which is 10 Mbps in this example) on a graph indicated by a band (unit: bps) and time (unit: min.). On the virtual matrix, rectangular regions occupied by the release bands are represented. As a result, the release band is represented in such a state that it is divided into minimum regions. The unit time T can be made equal in length to the resale execution unit time TR.

In this example, the subscriber can release the contract band by taking the unit time T and the minimum division bandwidth as minimum units. In the example of FIG. 9, the subscriber A is shown to release the band in time zones of T2 to T3 by 30 Mbps. With respect to the release band, other subscribers can issue band allocation requests (band use requests) by taking the minimum region as the unit.

Referring back to FIG. 5, the system control section 11 controls the band management display section 20. The band management display section 20 updates a band management table (referred to also as management table), and sets display information for the system (OPS) side and display information for subscriber (S07).

The band management display section 20 manages the band management table as shown in FIG. 2. The band management display section 20 reflects contents of the release band to the band management table by updating the band management table. Furthermore, the system control section 11 controls the band management display section 20, and the band management display section 20 displays the release region on a management network band information table serving as display information managed by itself.

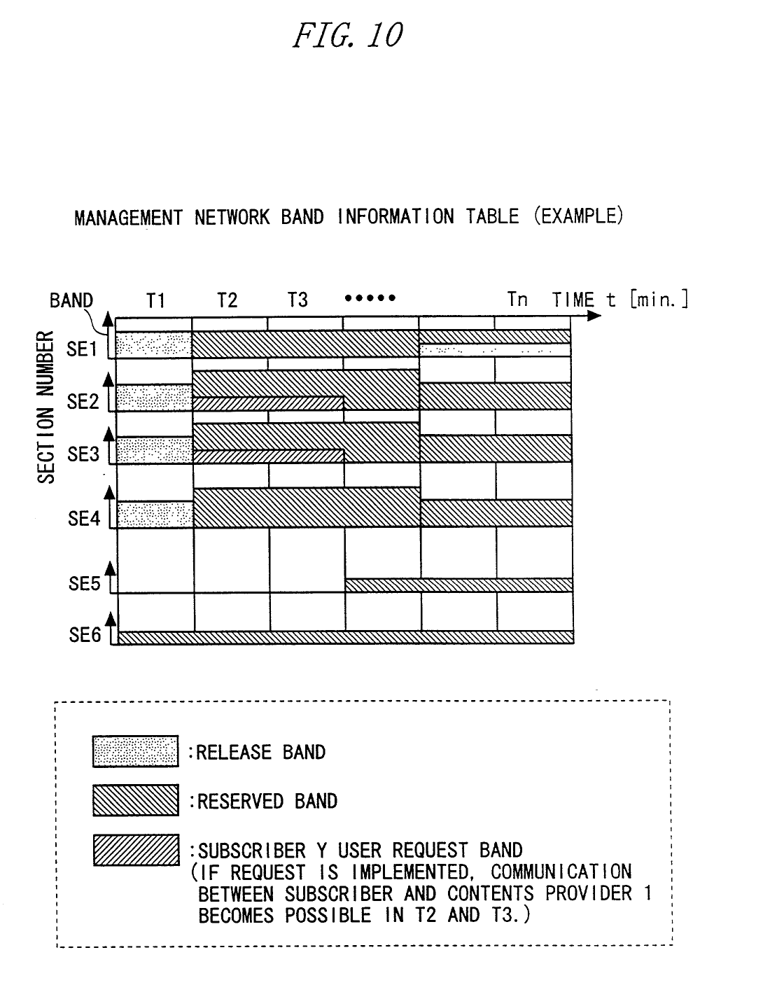

FIG. 10 is a diagram showing an example of the band information table. As shown in FIG. 10, the band information table indicates the communication band allocation situation (bandwidth and time zone) of each section, and already reserved bands and release bands are displayed with other modes (such as different colors and patterns).

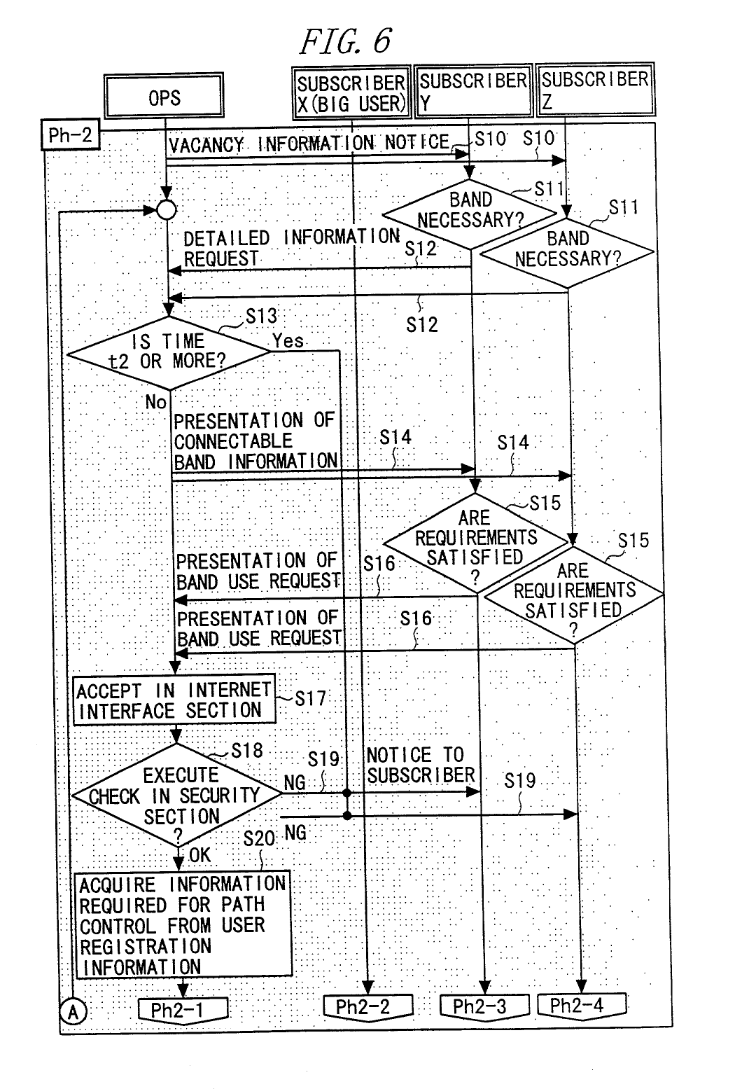

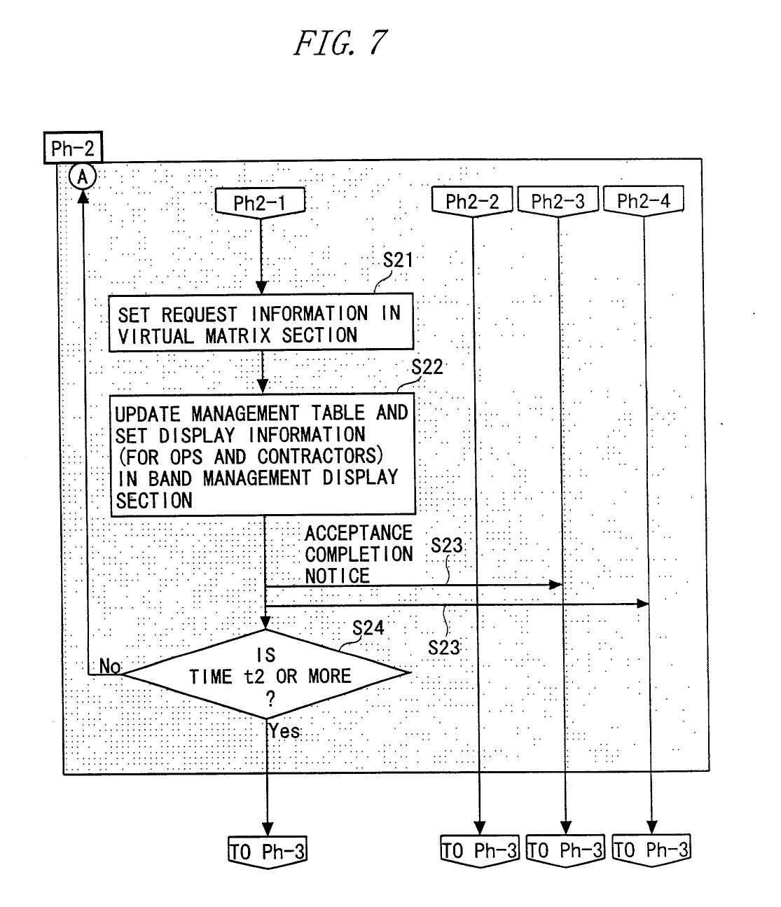

Referring back to FIG. 5, the system control section 11 sets resale time information (S08). The resale time information includes band release time t0 contained in the band release schedule notice, an acceptance termination time interval t1 of the release band utilization request (such as 5 minutes), and acceptance termination time t2 (=t0−t1). For example, if the band release time t0 is just three o'clock and the acceptance termination time interval t1 is 5 minutes, then the acceptance termination time t2 (=t0−t1) becomes two fifty-five. If the processing of S08 is finished, then the phase Ph-1 terminates and a transition to the Ph-2 shown in FIGS. 6 and 7 is conducted.

If the phase Ph-2 starts in FIG. 6, then other subscribers are informed of vacancy information which includes at least the fact that a release band has occurred (S10). The other subscribers are subscribers other than the subscriber who releases the band and who use terminal devices subordinate to the NE (accommodated in the NE) which becomes the subject of the band control when the release band is allocated to other subscribers. In the example shown in FIG. 3, subscribers Y and Z correspond to other subscribers. As for the notification technique, there can be applied an appropriate communication technique (such as an electronic mail via the Internet), or a technique for bringing about such a state that a web page carrying the vacancy information can be perused by the subscribers Y and Z. The vacancy information may also include the band release time t0 and/or the acceptance termination time t2.

Upon receiving the notice of the vacancy information, the subscribers Y and Z determine whether a further band is necessary (S11). If necessary, the subscribers Y and Z transmit a detailed information request to the OPS 10 (S12). On the other hand, if the band is not necessary, the subscribers Y and Z disregard the notice of the vacancy information.

Upon accepting the detailed information request, the system control section 11 in the OPS 10 determines whether the current time is past the acceptance termination time t2 (S13). If it is past the acceptance termination time (YES of S13), then an NG notice to the effect that the acceptance has been terminated is transmitted to other subscribers (S19). On the other hand, if it is not past the acceptance termination time t2 (NO of S13), information of bands which can be connected is presented (S14).

That is, the system control section 11 sends a web page containing the band information table and the resale time zones created by the management band display section 20, from the Internet interface section 18 (S14), Data of the sent web page are transferred to terminal devices of other subscribers (subscriber Y and/or Z) who have sent the detailed information requests, via the Internet.

In the terminal device, a web browser mounted thereon displays the web page on the display. As a result, the band information table carried by the web page assumes such a state that it is perused by (opened to) other subscribers (subscriber Y and/or Z), and release bands (sections, time zones, and bandwidths) are presented.

Each of other subscribers (subscriber Y and/or Z) peruses the band information table, and determines whether the release band meets the subscriber's own requirements (S15). The requirements indicate conditions of the time zone and bandwidth that each of the other subscribers desires to utilize.

If the release band does not meet the requirements, each of the other subscribers disregards the detailed information (band information table). On the other hand, if the release band meets the requirements, then the other subscriber presents a band use request (S16). The band use request is a request to use a part or all of the release band issued by the other subscriber, and it contains information (referred to as request information) which indicates the bandwidth and time zone of a band (use request band) the other subscriber requests (desires) to use, by using the minimum region units. The presentation of the band use request can be implemented by using a user interface carried by the web page.

A band use request transmitted from a terminal device of the other subscriber is accepted by the Internet interface section 18 of the OPS 10 (S17). Thereupon, the security section 19 checks this band use request (S18). If the check result is NG (NG of S18), then the other subscriber is notified of that effect. On the other hand, if the check result is OK (OK of S18), the system control section 11 acquires information required for the bus control (band control of the pertinent section) from the user registration information management section 12 (S20).

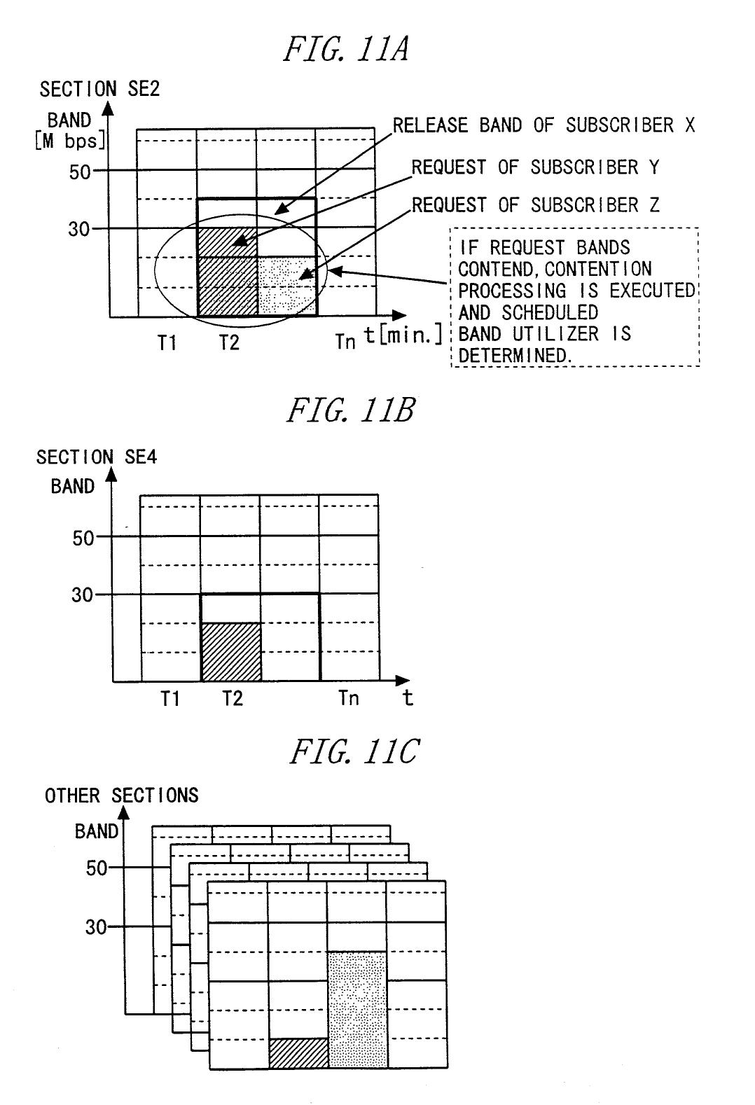

As shown in FIG. 7, the system control section 11 then sets the request information contained in the band use request in the pertinent virtual matrix by means of control of the virtual matrix management section 13 (S21). For example, as shown in FIG. 11(A), use request bands from other subscribers are written into the release band indicated on the virtual matrix.

The system control section 11 then updates the management table and updates the display information (for the system and for subscribers) by means of control of the band management display section 20 (S22). In other words, the system control section 11 reflects contents of use request bands of respective other subscribers to the band management table by updating the band management table by means of control of the band management display section 20. Further, the system control section 11 displays the use request bands on the band information table in a mode (bandwidth and time zone) different from the modes of the already reserved bands and the release band by means of control of the band management display section 20 (see FIG. 10).

Thereafter, an acceptance completion notice is transmitted from the OPS 10 to the terminal devices of the other subscribers who have transmitted the band use requests (S23). As for the acceptance completion notice, for example, the system control section 11 transmits data of a web page carrying a band information table which indicates the use request band to the pertinent terminal device via the Internet interface section 18. The terminal device displays the web page on the display to give notice. The acceptance completion notice may also be electronic mail.

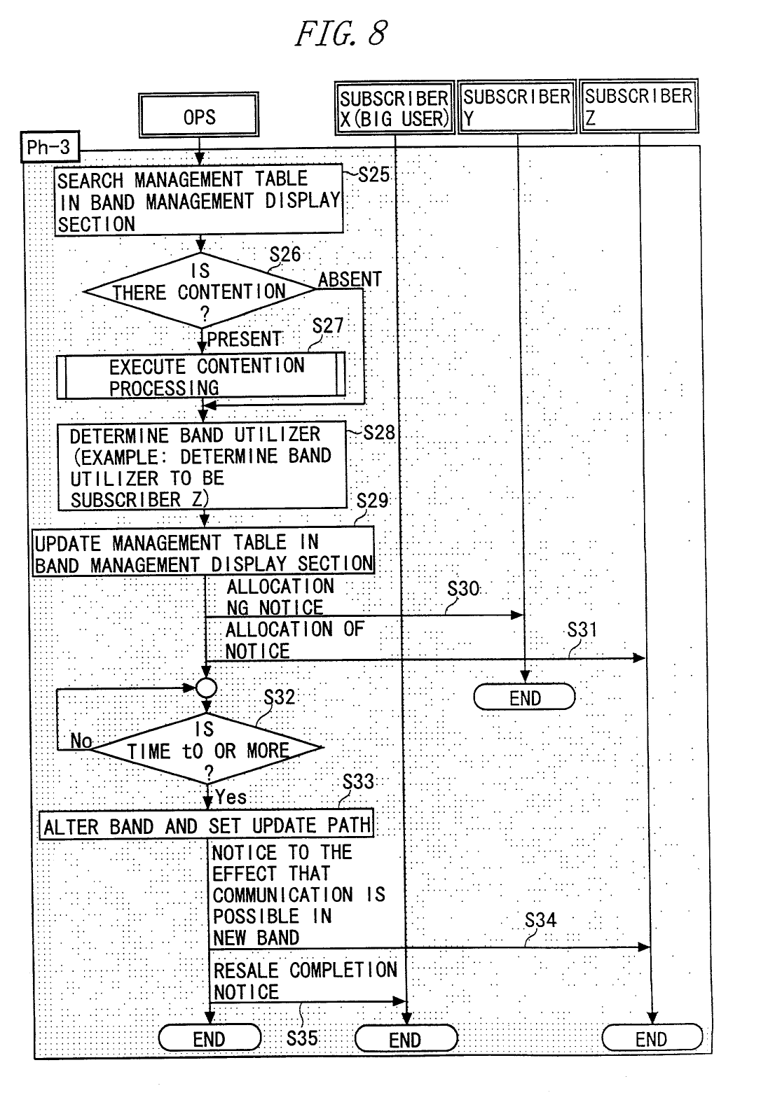

Upon transmission of the acceptance completion notice, the system control section 11 determines whether the current time is past the acceptance termination time t2 (S24). If the current time is not past the acceptance termination time t2 (NO of S24), then the processing returns to S13 to assume such a state that detailed information from other subscribers is accepted. On the other hand, if the current time is past the acceptance termination time t2 (YES of S24), then the processing moves to the phase Ph-3 shown in FIG. 8.

Upon start of the phase Ph-3 as shown in FIG. 8, the system control section 11 searches the band management table by means of control of the band management display section 20 (S25), and determines whether there is a contention, i.e., a plurality of use requests for a certain bandwidth of a certain time zone (S26) If there is no contention, the processing proceeds to S28. If there is a contention (present of S26), then the band resale determination section 14 executes contention processing (described later) (S27), and determines a band user (S28). As an example, it is now assumed that band resale for the subscriber Z has been determined.

The system control section 11 then updates the management table by means of control of the band management display section 20 and reflects the determination result of the band utilizer to the management table (S29). Thereafter, the system control section 11 transmits an allocation NG notice from the Internet interface section 18 to a subscriber (subscriber Y) left out of selection by the contention processing (S30), and transmits an allocation OK notice to a subscriber corresponding to the band utilizer (S31). These notices are conducted by, for example, transmitting data of a web page which indicates OK/NG of the allocation. Electronic mail may also be used.

Thereafter, the system control section 11 determines whether the current time has reached the band release time t0 (S32). If the current time has reached the band release time to (YES of S32), band alteration and new path setting processing is executed (S33). That is, the system control section 11 controls the path control section 16. The path control section 16 generates a path information setting command for establishing a path (or connection) according to the contents of the virtual matrix of the section in which the band is released, i.e., the alteration of the allocation situation caused by the resale, and transmits the path information setting command from the NE interface section 17 to the pertinent NE.

If there is no path of the band utilizer in the section in which the band allocation situation is altered, a path information setting command for newly setting a path of the band utilizer (which ensures the resold bandwidth) is generated. If there is already a path of the band utilizer, then alteration of policing setting for increasing the band of the path by the resold bandwidth is executed, and a path information command of the band increase is generated.

Upon receiving the path information setting command, the NE releases a path or decreases the band so as to decrease the band of the path of the subscriber who releases the band (subscriber X). On the other hand, for the subscriber (subscriber Z) corresponding to the band utilizer, the NE seizes the newly allocated band, connects a new path, and increases the band according to the policing setting.

As a result, it becomes possible for the purchaser to execute communication by using the newly allocated band. If the time zone resold to the purchaser has elapsed, the system control section 11 controls the bus control section 16, and restores the band allocation situation to the state preceding the execution of the resale. In this way, the subscriber can temporarily use the contract band of the other subscriber.

Thereafter, the OPS 10 transmits a notice to the subscriber (subscriber Z) corresponding to the band utilizer to notify the subscriber (subscriber Z) that communication using a new band is possible (S34). The OPS 10 transmits a resale completion notice to the subscriber (subscriber X) who has released the band (S35).

The billing information management section 15 sums up and holds the sum of the charge to be paid to the subscriber who has resold the band (who is referred to as reseller and who is now the subscriber X) by the subscriber (who is referred to as purchaser and who is now the subscriber Z). On the other hand, the billing information management section 15 sums up and holds the sums of fees to be paid to the carrier by the purchaser and the reseller.

Information of these amounts of money is utilized for adjustment of utilization charges of subsequent communication service. Of course, the amounts of money summed up may also be given and received between the persons concerned. As for the amount of money paid to the resold band, an amount of money for the minimum region of the release band is set, and the price to be paid to the reseller is determined by the number of the minimum regions purchased by the purchaser. Such processing conducted by the billing information management section 15 may be executed when the band allocation between the reseller and the purchaser is altered, or it may be executed when the original state is restored.

Owing to the on-demand band management control based on the resale processing as heretofore described, the reseller (mainly a big user) can reduce the utilization charge of communication service paid to the carrier by resaling unused bands. Other subscribers can utilize a further band without going through troublesome formalities such as contracts, and make the most of the communication service effectively. On the other hand, it becomes possible for the carrier to cope flexibly with a use request issued by a user. As a result, the utilization factor of the limited communication band can be increased, and new equipment investment can be avoided. By collecting the resale fee, the income can also be increased.

An example in which the above-described resale processing is applied to a network configuration shown in FIG. 3 will hereafter be described. In FIG. 3, there are NE1 to NE3 under the management control of the OPS 10. The NE1 is connected to the NE2 via a communication line (section SE1). The NE2 is connected to the NE3 via a communication line ((section SE4).

The NE1 can accommodate terminal devices of subscribers X, Y and Z via communication lines (sections SE1, SE6 and SE7) respectively. The NE2 accommodates a terminal device of a first contents provider (contents provider 1) via a communication line (section SE3). The NE3 accommodates a terminal device of a second contents provider (contents provider 2) via a communication line (section SE5). The terminal devices of the subscribers X, Y and Z are connected to the OPS 10 via the Internet.

The terminal device of the subscriber X conducts communication with the terminal device of the contents provider 1 via a communication route of SE1-SE2-SE3, and conducts communication with the terminal device of the contents provider 2 via a communication route of SE1-SE2-SE4-SE5. The subscriber X ensures bands for executing these communications by means of contracts. Hereafter, main processing of the resale processing will be extracted and described.

[1] Processing at the Time of Band Release

Vacant bands of each section on the route of the released path are reflected to the virtual matrix. It is assumed in FIG. 3 that the subscriber X is using bands by taking 10 Mbps as the unit as follows.

The communication route of SE1-SE2-SE4-SE5: 10M×3=30M

The communication route of SE1-SE2-SE3: 10M×1=10M

In the case where these bands are not used in a certain time zone (2T), the subscriber X executes release (resale). In that case, vacant bands between nodes (NEs or terminal devices) become as follows.

Section SE2 (NE1-NE2): 40M×2T

Section SE3 (NE2-contents provider 1): 10M×2T

Section SE4 (NE2-NE3): 30M×2T

Section SE5 (NE3-contents provider 2): 30M×2T

These vacant band information pieces are managed in the virtual matrix (see FIG. 9) of the virtual matrix management section 13. That is, vacant bands (unused bands) on the virtual matrix of the section SE2 are 40M, vacant bands on the virtual matrix of the section SE3 are 10M, and vacant bands on the virtual matrix of the section SE4 are 30M.

In the example shown in FIG. 2, a big user uses bands of a total of 5 routes (S1-R1, S2-R2, S3-R3, S4-R4, and S5-R5) with 10M per route. In the case where these bands are not used during time Te to Ts, release (resale) is conducted. In this case, the vacant band between nodes is 50M between A1 and C1, 40M between C1 and C2, 30M between C2 and A3, 10M between C2 and A4, and 10M between C1 and A2. These vacant band information pieces are managed on the virtual matrix of the virtual matrix management section 13. That is, the vacant band on the virtual matrix of the section (a) is 30M, the vacant band on the virtual matrix of the section (b) 30M, the vacant band on the virtual matrix of the section (c) 40M, and the vacant band on the virtual matrix of the section (d) 10M.

[2] Processing of Presenting Vacant Band Information to Other Subscribers

If the band released by the subscriber X in the network configuration of FIG. 3 has become 20M×2T in the section SE2, 10M×2T in the section SE3 and 30M×2T in the section SE4, then information of vacant bands (release bands) is set on the virtual matrix of each section, edited for display in the management band display section 20 (the band management table is edited) and opened to other subscribers Y and Z via the Internet.

As a result, each of the subscribers Y and Z recognizes that a band of a maximum of 10M×2T is a vacant band (release band) in the communication route of the sections SE2-SE3 and a band of a maximum of 30M×2T is a vacant band (release band) in the communication route of the sections SE2-SE4. On the basis of the information, each the subscribers Y and Z issues a band utilization request.

[3] Band Resale Processing

If the subscriber Y desires the use of the band of 30M×T for the section SE2 and the subscriber Z desires the use of the band of 20M×2T, the subscribers Y and Z make reservations via the Internet. A resultant setting example is shown on the virtual matrix of the section SE2 of FIG. 11(A). As a result, the use request band of the subscriber Y and the use request band of the subscriber Z partially overlap. By execution of contention processing, therefore, the band utilizer is determined. If there are no overlapping portions, it is a matter of course that the band use requester becomes the band utilizer.

If the band utilizer is determined, the determined situation is set. In other words, reserved use is reflected to the virtual matrix data. In addition, the determined situation is set in the band management table as well, and it is opened to users in the next resale time zone.

Upon arrival at the band reservation time, the path control section 16 cancels use information of the previous band. In the case of a new user (a subscriber for whom a path is newly set in that section), path setting is conducted. In the case of an existing user (a subscriber having a path already set in that section) and band addition, policing setting is altered.

[4] Contention Processing

If requests overlap in the band resale, a band utilizer is determined by a contention processing scheme described hereafter. If as a result a band having no allocations occurs, the remaining band is allocated by executing a non-preferential band resale scheme described later.

[Contention Processing Scheme]

At the time of band utilization request, the vacant band utilization requester (band utilization requester) declares the bandwidth (Bi), use time zone (Ti), and utilization priority index (Pi). (These kinds of information are contained in the band utilization request and transmitted to the OPS 10.)

In the OPS 10, the band resale determination 14 calculates a band re-utilization factor (Ri) and a resale value (Si) on the basis of the contents of the declaration. By a comparison thereof, a subscriber having a greatest resale value Si is determined preferentially as a band utilizer.

The utilization priority index Pi, the band re-utilization factor Ri, and the resale value Si can be defined, for example, as follows, (where i is a subscriber identifier, and in this example, i=X, Y or Z.)

Definition of utilization priority index Pi

Pi=1: ordinary utilization (billing factor 1.0)

Pi=2: preferential utilization (billing factor 1.5)

Pi=3: the most preferential utilization (billing factor 2.0)

※ The number of ranks (classes) and the billing factor can be set appropriately. (As for the billing factor, ordinary<preferential<the most preferential)

Definition of band re-utilization factor Ri

Ri=request band (Ui=ΣBj×Tj)/release band

Definition of resale value Si

Si=ΣBj×Tj×Pj/release band

where j is the minimum unit of the virtual matrix (time zone and bandwidth which represent the minimum region). The request band of the utilizer becomes the sum total of the areas (Bj×Tj) of the minimum regions.

A concrete example of the value of Si will be shown hereafter. Assuming that all Pj=2 for brevity in the example of SE2 shown in FIG. 11(A),

the resale value SY (i=Y) of the subscriber Y is SY=30/80×PY(2)=0.75

the resale value SZ (i=Z) of the subscriber Z is SZ=40/80×PZ(2)=1.00.

Therefore, allocation is determined on the subscriber Z having a greater resale value Si. Typically, Pj can be varied every minimum unit (minimum region) of the virtual matrix.

If the priority index Pj is the same, then a subscriber having a higher utilization factor of the release band (having a higher band re-utilization factor Ri) is thus selected preferentially to improve the band utilization efficiency. If the priority indexes Pj are different, however, then a subscriber having a higher priority index Pj is selected preferentially. If the priority index Pj is increased, however, the billing factor of the price for the reseller and/or the fee is also increased.

[Nonpreferential Band Resale Scheme]

The nonpreferential band resale scheme is a scheme in which band specification is not conducted in a specific time zone and band allocation is conducted so that request bands may be ensured within a certain time limit. At the time of the band utilization request, the service utilizer based on this scheme declares a request band (Ui=ΣBj×Tj) and a time limit (example: within three hours) in addition to the ordinary declaration contents. As a result, band allocation can be executed as much as possible according to the vacant band quantity within the time limit. Thus, the utilization efficiency of the communication band can be increased.

In the case where the nonpreferential band resale scheme is executed, information indicating the request band and the time limit declared by the subscriber is accepted by the band management control system (OPS 10), and connected to a dedicated processing queue. As a result, band allocation is executed in the order of acceptance.

Even if a user is not selected as the band utilizer as a result of the contention processing, a vacant band remains and all or a part of the request band can be allocated to the vacant band, in some cases. In this case, the user is notified of the time zone and bandwidth of the vacant band (the pertinent time section and additional bandwidth at that time). Thereafter, at the head of the pertinent time, the system automatically conducts the bandwidth alteration by means of policing alteration. In other words, when the band release time is arrived at, a part or all of the request band is allocated to the vacant band. If a part is allocated, then the remaining band is allocated in resale processing in the case where a vacant region occurs at the next time.

Hereafter, an example of the nonpreferential band resale scheme will be described.

(Example) If the release band (all resale band)=50Mbps and allocation of 35M is determined as a result of the contention processing, then the remaining resale band is 15M. This band is allocated to a user (Ui=20M) who has applied for the nonpreferential band resale. In this time zone, policing is set so as to allow only 15M. The remaining 5M is processed when a vacant band occurs the next time.

(Embodiment)

Hereafter, an embodiment of the present invention will be described. There will be described the case where resale processing is executed under the following conditions in the system including the band management control system (OPS 10) shown in FIGS. 2 and 3.

A communication band is sold and bought by taking 5Mbps and 30 minutes as the unit every communication path (section).

If the band selling and buying (resale) is agreed, the selling user (reseller) receives a band rent (price) from the buying user (purchaser).

The carrier collects 10% of the band rent (price) as a fee from each of the selling user (reseller) and the buying user (purchaser).

The OPS 10 has an Internet connection function (implemented by the system control section 11, the Internet interface section 18, and soon), a real time band selling and buying control function (implemented by the system control section 11, the user registration information management section 12, the virtual matrix management section 13, the band resale determination section 14, the Internet interface section 18, the management band display section 20, and so on), a communication path information display function (implemented by the system control section 11, the Internet interface section 18, the management band display section 20, and so on), a user billing information control function (implemented by the system control section 11, and the billing information management section 15), a communication band control function (implemented by the system control section 11, the virtual matrix management section 13, and so on), and a path connection control function (implemented by the system control section 11, the virtual matrix management section 13, the path control function 16, the NE interface section 17, and so on).

The OPS 10 provides users (subscribers) with a web site which updates and displays on real time the communication path information, the communication band selling and buying agreement and order situation (brief/detailed), and individual user's band selling and buying agreement and order situation.

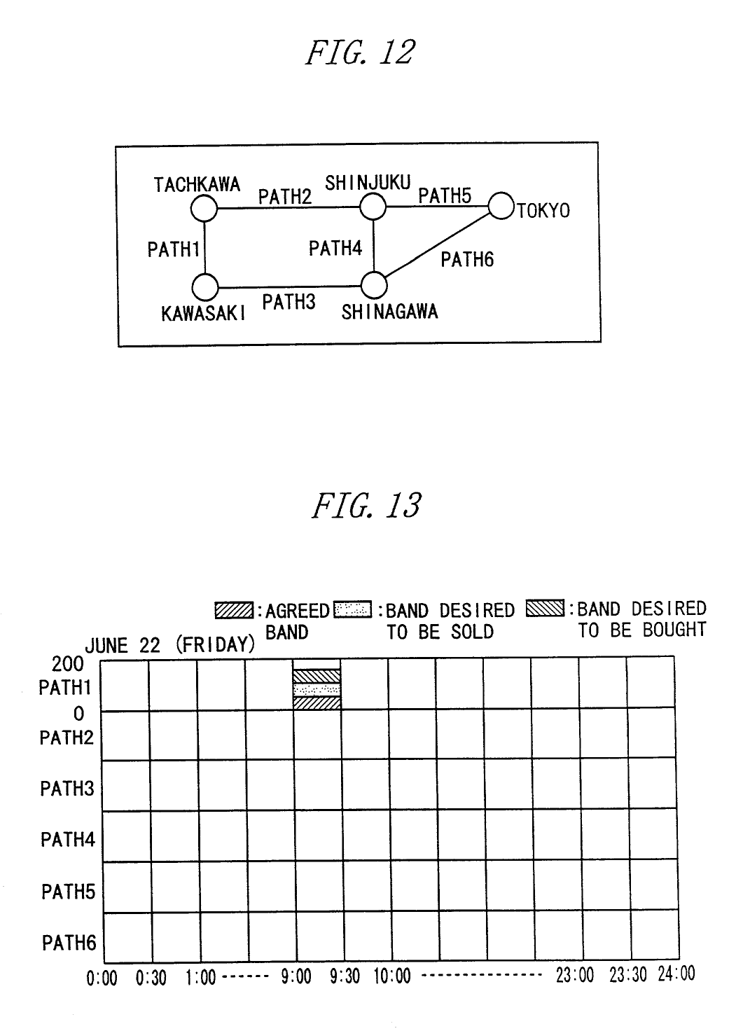

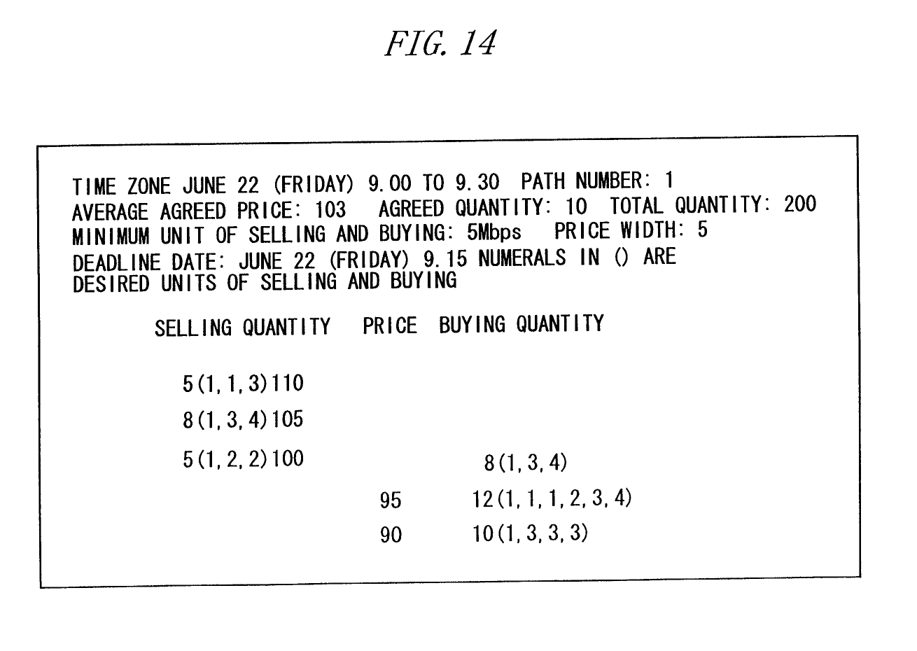

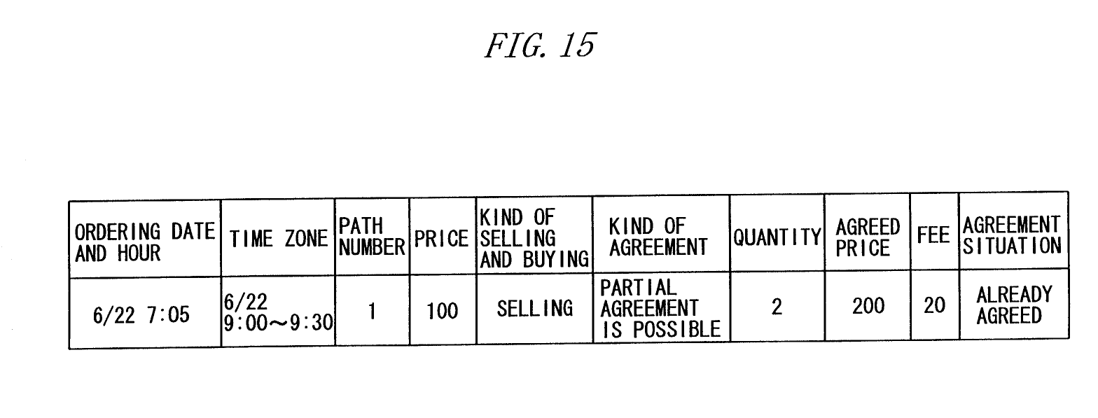

FIGS. 12 to 16 are diagrams showing screen display examples of the web site. FIG. 12 shows a display example of the communication path information. FIG. 13 shows a display example of the communication band selling and buying agreement and order situation (brief). FIG. 14 shows a display example of the communication band selling and buying agreement and order situation (detailed). FIG. 15 shows a display example of the individual user's band selling and buying agreement and order situation.

The user (subscriber) accesses the web site via the Internet, and refers to the communication path information and the band selling and buying agreement and order situation (brief/detailed). If the subscriber wants to resale an unused band (vacant band) in the contract band of the subscriber, then the subscriber issues a band selling and buying order to the OPS 10.

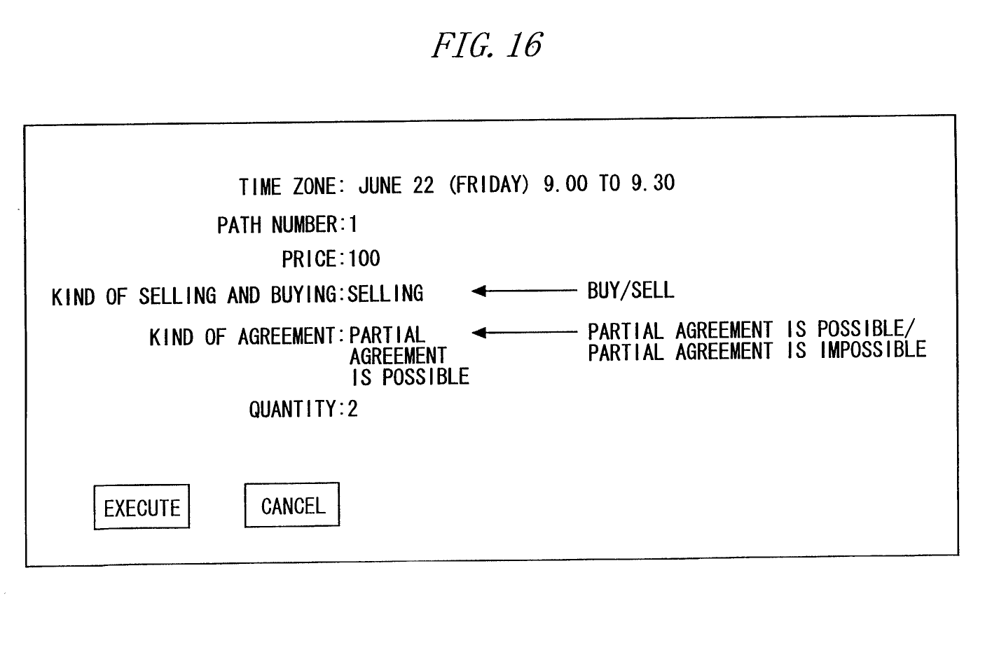

To be concrete, the subscriber serving as the reseller uses a band selling and buying order format (provided as one of the web pages from the web site) shown in FIG. 16, specifies on the format a time zone, path number, price, kind of selling and buying, kind of agreement, and quantity for specifying a release band to be resold (if the bandwidth desired to be sold and bought is 40 Mbps, the quantity is 8 because 40 Mbps is equal to 5 Mbps×8), and clicks an execution button. In this way, a band selling and buying order is issued in real time. The subscriber can confirm the order situation by referring to a web page, which indicates the individual user's band selling and buying agreement and order situation.

If conditions of the selling user (reseller) and the buying user (purchaser) coincide with each other every minimum selling and buying unit (every minimum region shown in FIG. 9), then an agreement is reached. At this time, appropriate conditions can be determined as agreement rules. For example, the agreement rules can be determined as follows: the price takes precedence; if the price is the same, the time takes precedence; and cancel after the agreement is not permitted. The subscriber can confirm the agreement situation by referring to the individual user's band selling and buying agreement and order situation display.

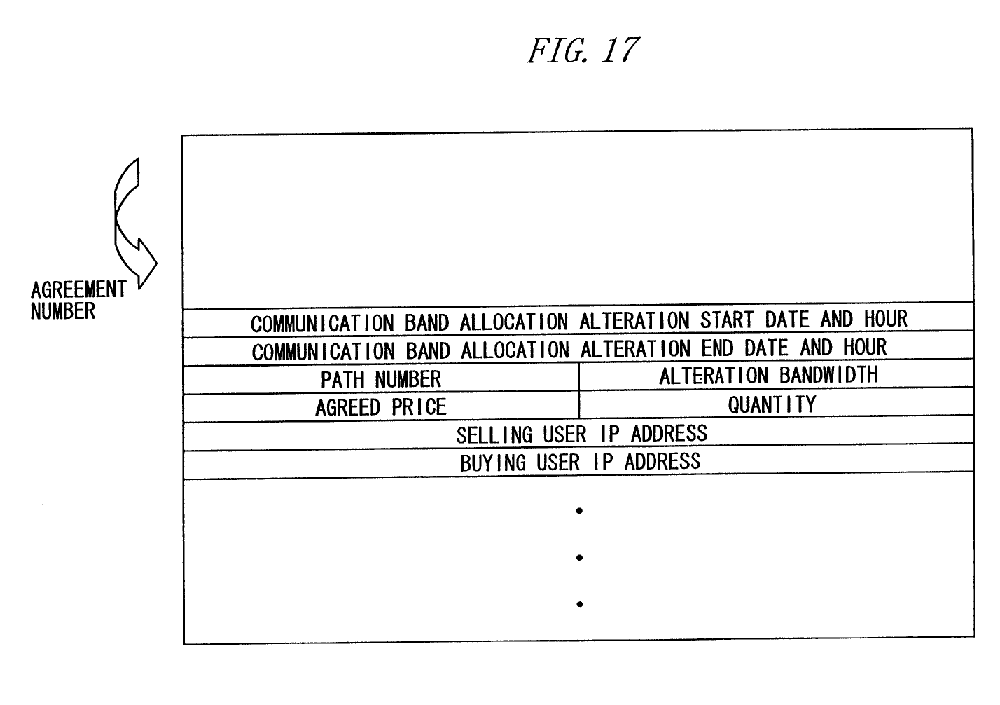

Thereafter, if the band allocation alteration start date (band release time) is reached, the OPS 10 refers to a band selling and buying agreement information management table (corresponding to the band management table) as shown in FIG. 17. With respect to the band of the agreed communication path, the OPS 10 conducts band release processing of the reseller, request band acquisition processing, and path connection switch over (from the reseller to the purchaser).

Thereafter, if the band allocation alteration end date (allocation end time of the band to the purchaser) is reached, the OPS 10 refers to the band selling and buying agreement information management table. With respect to the agreed band, the OPS 10 conducts band release processing (the purchaser), band acquisition processing (the reseller), and path connection switchover (from the purchaser to the reseller).

By referring to the band selling and buying agreement information management table, the OPS 10 updates the billing information of the selling user (reseller) and the buying user (purchaser).

The second means implemented by the band management control system according to the present invention will now be described. If it is desired to ensure a band other than a vacant band in the contract band of another subscriber like the subscriber B who has not ensured as shown in FIG. 1, the subscriber transmits the requirements to the band management control system (OPS 10).

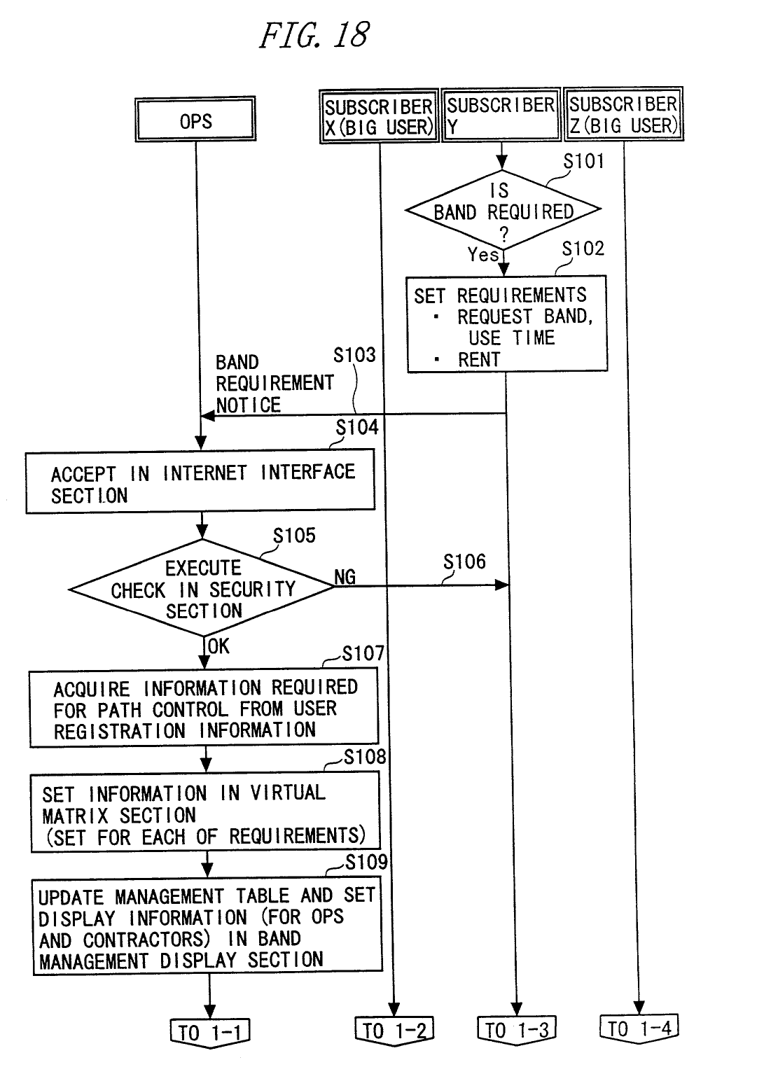

FIGS. 18 to 20 are flow charts showing resale processing of the band management control system (OPS 10) in implementing the second means. Hereafter, contents of the processing will be described by referring to the flow charts.

In FIG. 18, the subscriber Y needs a band. If a vacant band, which meets the condition of the subscriber Y, is not present, however, the subscriber Y sets requirements, and notifies the band management control system (OPS 10) of band requirements (S101, S102 and S103). The requirements contain at least information indicating the request bandwidth, use time zone, and utilization charge.

In the band management control system (OPS 10), the Internet interface section 18 accepts the band requirement notice, and the security section 19 executes a check (S104 and S105). If the check result is NG (NG of S105), then the subscriber Y is notified to that effect, and the subsequent processing of the OPS 10 is not conducted.

If the check result is OK (OK of S105),information required for the path control is acquired from the user registration information management section 12 (S107), and information is set on the virtual matrix managed by the virtual matrix management section 13 (S108). In other words, the information of the request bandwidth and time zone contained in the requirements is set on the virtual matrix contained in the requirement notice. Setting of requirements on the virtual matrix is conducted every requirement.

The band management display section 20 updates the band management table and sets band request display information (for the system and for the subscriber) (S109). The display information contains the virtual matrix of the section for which the band request has been issued.

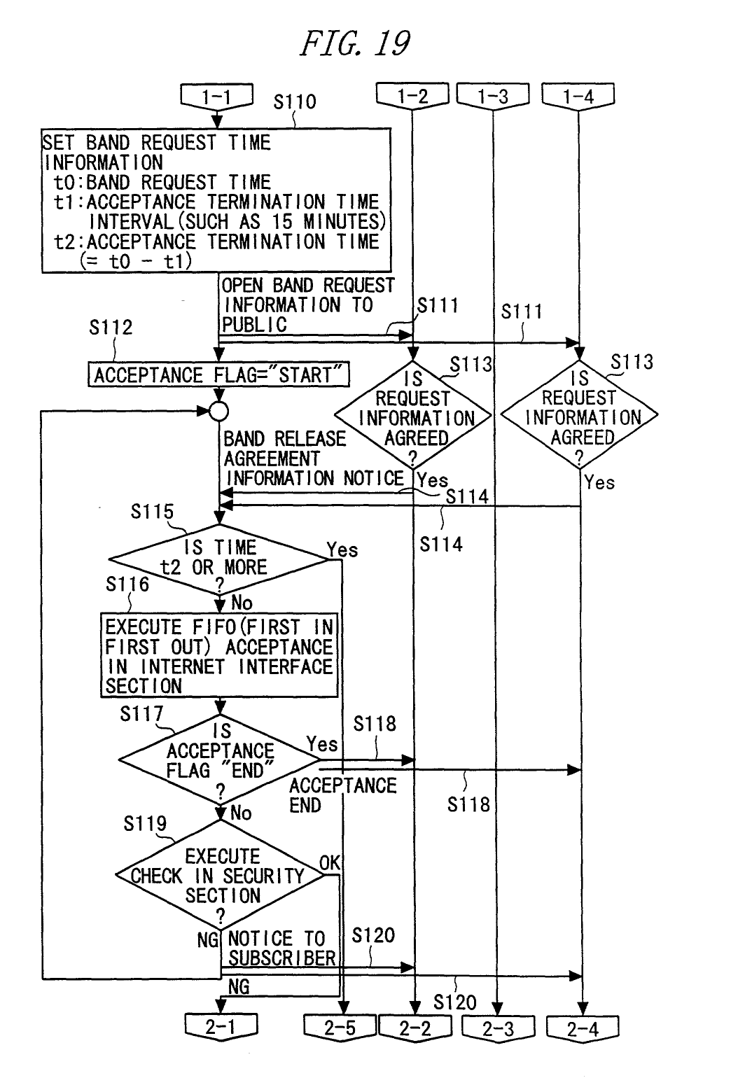

As shown in FIG. 19, the band request time information (t0: band request time, t1: acceptance termination time interval, t2: acceptance termination time (=t0 −t1)) is then set (S111). The band request display information (band request information) is transmitted to all subscribers through the Internet, and the band request information is opened to the public (S111). Further, an acceptance flag=“start” is set (S112).

In the case where a subscriber ensuring the request band in the contract band refers to the band request information and agrees to the requirements (YES of S113), the subscriber transmits a band release agreement information notice to the band management control system (OPS 10) via the Internet (S114).

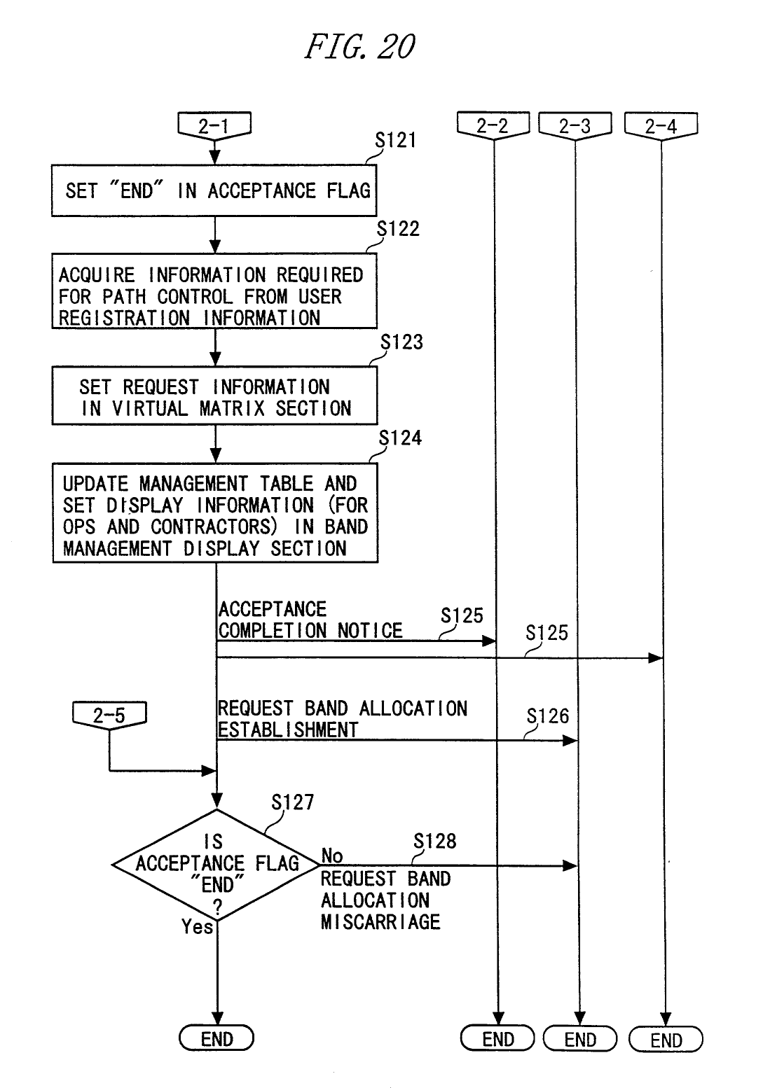

The band management control system (OPS 10) checks the acceptance termination time t2 (S115). If the band release agreement information notice is judged to have reached within the acceptance time (YES of S115), the Internet interface section 18 conducts FIFO (First In First Out) type acceptance (S116) On the other hand, if it is past the acceptance termination time t2, but the acceptance flag is not “end” (NO of S127 in FIG. 20), a request band allocation miscarriage notice is sent to the subscriber Y (S128).

Referring back to FIG. 19, if band release agreement information notices from one or more subscribers are accepted in the FIFO form, loop processing of S115 to S119 is executed subscriber after subscriber. If the acceptance flag=“end” in S117 (YES of S117), then an acceptance termination notice is returned to notify the band release agreement information notifying subscribers that the request band allocation has been established (S118). In other words, the present service (resale in the second means) is a preference determination scheme in which the subscriber who has agreed to the requirements the earliest can resale a band to band requesters.

If in S117 the acceptance flag is not “end” (NO of S117); the security section 18 of the band management control system (OPS 10) checks the band release agreement information notice (S119). If the check result is NG (NG of S119), pertinent subscribers are notified to that effect (S120). Thereafter, the processing returns to S115. Until a result of check OJ is obtained first as to the band release agreement information notice accepted in the FIFO form, the loop processing is repeated.

If the result of the security check OK is obtained at S119 (OK of S119), then “end” is set in the acceptance flag (S121 of FIG. 20). Thereupon, information required for the path control is acquired from the user registration information management section 12 (S122),and the agreed request information is set on the virtual matrix of the virtual matrix management section 13 (S123). The band management display section 20 updates the band management table, and executes the display information setting (for the system and for the subscribers) (S124). In addition, acceptance completion notices are transmitted to the subscribers who have agreed to the band request (S125), and a request band allocation establishment notice (resale establishment notice) is sent to the subscriber Y who is the band requester (S126).

Thereafter, the OPS 10 executes the band allocation alteration on the section for which the resale has been established by using a technique similar to that of the first means. In addition, the OPS 10 bills the rent for the resold band and the fee for the carrier.

According to the first means implemented by the band management control system according to the present invention, band management control is conducted on a vacant band which occurs in an unused time zone, abruptly, or in a short period of time with respect to a band previously allocated to a user (contractor or a subscriber), and the band is resold to other users in an on-demand form.

Thus, by reselling vacant bands (unused portions), band use requests from users can be coped with flexibly, and communication service, which is high in utility value to users, can be provided. Further, since the user (especially a user having a wideband allocated thereto, i.e., a big user) corresponding to the reseller can collect a rent from the user corresponding to the purchaser, the use cost of the contract band can be reduced. Further, since unused bands are allocated to other subscribers, the bands can be made the most of. Therefore, improvement of the band utility factor in the limited communication facilities can be implemented. And by collecting the fee of resale, the carrier can increase the income.

Further, according to second means implemented by the band management control system, not only resale of unused bands but also resale of bands to be used by a certain subscriber can be implemented so long as the subscriber complies with a band requirement of another user (a rent in the above-described example). As a result, it becomes possible to bring benefits on both subscribers. In other words, the subscriber serving as the reseller can reduce the use cost of the communication band by obtaining the rent. The subscriber serving as the purchaser can execute desired communication by using an additional band. In addition, the carrier can increase the income by collecting the fee resulting from the resale.

The present invention can be specified as a communication band control system, which executes only one of the first means and the second means, and its method. Further, the present invention can also be specified as a communication band control system, which executes only nonpreferential band resale processing, and its method. The nonpreferential band resale processing may be executed irrespective of the execution of the contention processing. The communication band control system may also be implemented by a combination of a device (such as a server) for opening information to users and a device for executing the band control.

What is claimed is:

1. A communication band control system for executing communication band allocation control in a network in which communication bands are previously allocated to one or more users, said communication band control system comprising:
opening means for opening an unused portion of a communication band previously allocated to a certain user, to other users;
acceptance means for accepting use requests of all or a part of the unused portion, from other users; and
allocation alteration means for allocating all or a part of the unused portion that corresponds to use requests, to a different user.

2. A communication band control system according to claim 1, further comprising rent billing means for billing rents to be paid to said certain user, for all or a part of the unused portion allocated temporarily to a different user, by the different user.

3. A communication band control system according to claim 1, further comprising contention processing means, responsive to a contention of use requests from a plurality of other users for the unused portion, for selecting a user having a highest use factor of the unused portion, as the different user to be allocated all or a part of the unused portion.

4. A communication band control system according to claim 3, wherein
said contention processing means derives a product of a priority index respectively declared by each of the plurality of other users and a use factor of the unused portion, for each of the other users, and selects a user having a largest product as a different user to be allocated all or a part of the unused portion, and
said billing means bills a rent according to a priority index declared by the selected different user.

5. A communication band control system according to claim 1, wherein
said acceptance means accepts a nonpreferential use request including information which indicates a value of a communication band desired to be allocated with in a predetermined time limit, from a user, and
said allocation alteration means allocates unused portions of communication bands opened to public after acceptance of the nonpreferential use request and previously allocated to users except the nonpreferential user who has declared the nonpreferential use request, to the nonpreferential user until a total value of the communication band allocated to the nonpreferential user within the time limit reaches a value desired in the nonpreferential use request.

6. A communication band control system according to claim 3, wherein
said allocation alteration means includes a time limit for insurance of a communication band desired in a use request by an unselected user included in other users who are not selected by said contention processing means,
when allocating a part of the unused portion to the different user selected by said contention processing means, said allocation alteration means allocates a remaining part of the unused portion to the unselected user, and
said allocation alteration means allocates unused portions of communication bands opened to public thereafter and previously allocated to users except the nonpreferential user, to the nonpreferential user until a total value of the communication band allocated to the nonpreferential user within the time limit reaches a communication band desired in the use request.

7. A communication band control system according to claim 1, further comprising creation means for creating a virtual matrix having portions obtained by dividing a rectangle which shows an used portion by unit rectangles each having a unit bandwidth and a unit time length, wherein
said opening means opens the unused portion represented by the virtual matrix to public,
said acceptance means accepts a use request of all or a part of the unused portion specified by taking the unit rectangle as unit,
said creation means represents all or a part of the unused portion requested by the different user who is accepted by said acceptance means and determined to be allocated, on the virtual matrix, and
said allocation alteration means allocates all or a part of the unused portion to the different user based on the virtual matrix.

8. A communication band control system according to claim 1, wherein
said acceptance means accepts a temporary use request of a communication band which is not previously allocated to a user, and conditions of complying with the use request,
said opening means opens the use request and conditions to other users,
said acceptance means accepts consents to the use request and conditions from other users, and
said allocation alteration means temporarily allocates communication bands previously allocated to other users who have given the consents to the use request and conditions, to the user who has issued the use request.

9. A communication band control system according to claim 1, further comprising fee billing means, responsive to a communication band allocation alteration conducted by said allocation alteration means, for billing at least a user of the alteration destination for a fee.

10. A communication band control system according to claim 1, wherein said opening means opens a situation of a communication band previously allocated to a certain user, to users via Internet in such a state as to reflect the unused portion and a portion for which the use request has been made.

11. A communication band control system for executing communication band allocation control in a network in which communication bands are previously allocated to one or more users, said communication band control system comprising:
acceptance means for accepting a use request containing information indicating a value of a communication band which is not previously allocated to a user and desired to be temporarily allocated within a predetermined time limit, and
allocation alteration means for allocating unused portions of communication bands previously allocated to users except the request user who has requested the use, to the request user, after acceptance of the use request, until a total value of the communication band temporarily allocated to the request user within the time limit reaches a value desired in the use request.

12. A communication band control system for executing communication band allocation control in a network in which communication bands are previously allocated to one or more users, said communication band control system comprising:
acceptance means for accepting a temporary use request of a communication band that is not previously allocated to a user, and conditions of complying with the use request;
opening means for opening the use request and conditions to other users;
allocation alteration means responsive to acceptance of consents to the use request and conditions from other users conducted in said acceptance means, for temporarily allocating communication bands previously allocated to the other users, to the user who has issued the use request.

13. A communication band control method for executing communication band allocation control in a network in which communication bands are previously allocated to one or more users, said communication band control method comprising:
an opening step for opening an unused portion of a communication band previously allocated to a certain user, to other users;
an acceptance step for accepting use requests of all or a part of the unused portion, from other users; and
an allocation alteration step for allocating all or a part of the unused portion that corresponds to use requests, to a different user.

14. A communication band control method according to claim 13, further comprising a rent billing step for billing rents to be paid to said certain user, for all or a part of the unused portion allocated temporarily to a different user, by the different user.

15. A communication band control method according to claim 13, further comprising a contention processing step, responsive to a contention of use requests from a plurality of other users for the unused portion, for selecting a user having a highest use factor of the unused portion, as the different user to be allocated all or a part of the unused portion.

16. A communication band control method according to claim 15, wherein
said contention processing step derives a product of a priority index and a use factor of the unused portion declared by each of the plurality of other users, for each of the other users, and selects a user having a largest product as a different user to be allocated all or a part of the unused portion, and
said billing step bills a rent according to a priority index declared by the selected different user.

17. A communication band control method according to claim 13, wherein
said acceptance step accepts a nonpreferential use request containing information which indicates a value of a communication band desired to be allocated within a predetermined time limit, from a user, and
said allocation alteration step allocates unused portions of communication bands opened to public after acceptance of the nonpreferential use request and previously allocated to users except the nonpreferential user who has declared the nonpreferential use request, to the nonpreferential user until a total value of the communication band allocated to the nonpreferential user within the time limit reaches a value desired in the nonpreferential use request.

18. A communication band control method according to claim 15, wherein
said allocation alteration step contains a time limit for insurance of a communication band desired in a use request by an unselected user included in other users who are not selected by said contention processing step,
when allocating a part of the unused portion to the different user selected by said contention processing step, said allocation alteration step allocates a remaining part of the unused portion to the unselected user, and
said allocation alteration step allocates unused portions of communication bands opened to public thereafter and previously allocated to users except the nonpreferential user, to the nonpreferential user until a total value of the communication band allocated to the nonpreferential user within the time limit reaches a communication band desired in the use request.

19. A communication band control method according to claim 13, further comprising a creation step for creating a virtual matrix having portions obtained by dividing a rectangle which shows an used portion by unit rectangles each having a unit bandwidth and a unit time length, wherein
said opening step opens the unused portion represented by the virtual matrix to public,
said acceptance step accepts a use request of all or a part of the unused portion specified by taking the unit rectangle as unit,
said creation step represents all or a part of the unused portion requested by the different user who is accepted by said acceptance step and determined to be allocated, on the virtual matrix, and
said allocation alteration step allocates all or a part of the unused portion to the different user based on the virtual matrix.

20. A communication band control method according to claim 13, wherein
said acceptance step accepts a temporary use request of a communication band which is not previously allocated to a user, and conditions of complying with the use request,
said opening step opens the use request and conditions to other users,
said acceptance step accepts consents to the use request and conditions from other users, and
said allocation alteration step temporarily allocates communication bands previously allocated to other users who have given the consents to the use request and conditions, to the user who has issued the use request.

21. A communication band control method according to claim 13, further comprising a fee billing step, responsive to a communication band allocation alteration conducted by said allocation alteration step, for billing at least a user of the alteration destination for a fee.

22. A communication band control method according to claim 13, wherein said opening step opens a situation of a communication band previously allocated to a certain user, to users via Internet in such a state as to reflect the unused portion and a portion for which the use request has been made.

23. A communication band control method for executing communication band allocation control in a network in which communication bands are previously allocated to one or more users, said communication band control method comprising:
an acceptance step for accepting a use request containing information indicating a value of a communication band which is not previously allocated to a user and desired to be temporarily allocated within a predetermined time limit, and
an allocation alteration step for allocating unused portions of communication bands previously allocated to users except the request user who has requested the use, to the request user, after acceptance of the use request, until a total value of the communication band temporarily allocated to the request user within the time limit reaches a value desired in the use request.

24. A communication band control method for executing communication band allocation control in a network in which communication bands are previously allocated to one or more users, said communication band control method comprising:
an acceptance step for accepting a temporary use request of a communication band that is not previously allocated to a user, and conditions of complying with the use request;
an opening step for opening the use request and conditions to other users;
an allocation alteration step responsive to acceptance of consents to the use request and conditions from other users conducted in said acceptance step, for temporarily allocating communication bands previously allocated to the other users, to the user who has issued the use request.
